(19) United States
(12) Patent Application Publication
(10) Pub. No.: US 2026/0051818 A1
(43) Pub. Date: Feb. 19, 2026

(54) OUTPUT VOLTAGE ADJUSTMENT CIRCUITRY OF A MULTILEVEL CONVERTER

(71) Applicant: Apple Inc., Cupertino, CA (US)

(72) Inventors: Jonathan M Audy, Los Gatos, CA (US); Armando Presti, Austin, TX (US)

(21) Appl. No.: 18/804,351

(22) Filed: Aug. 14, 2024

(51) Int. Cl. H02M 3/158; H02M 1/00; H02M 1/08; H02M 3/07; H02M 7/483

(52) U.S. Cl. CPC H02M 3/158; H02M 1/08; H02M 3/07; H02M 1/0095; H02M 7/4837

(57) ABSTRACT

This disclosure is generally directed to a multilevel converter with coarse output voltage adjustment circuitry. The multilevel converter may include circuitry to adjust a value of the output voltage by repeating energizing and/or de-energizing phases (e.g., patterns) to generate the output voltage with a desired voltage value. The repeating patterns of energizing and de-energizing phases may be associated with a higher rate of voltage change compared to other multilevel converters. As such, the multilevel converter may adjust the output voltage with a reduced duration based on the higher voltage adjustment rate.

### BACKGROUND

The present disclosure relates generally to circuitry to control an output voltage of a multilevel converter of an electronic device.

An electronic system may include one or more multilevel converters to generate desired voltage levels for performing one or more operations. A multilevel converter may generate an output voltage based on a voltage value of an input voltage. The voltage level of the output voltage may be adjusted based on various reasons. For example, the output voltage may be adjusted based on a change in the input voltage, voltage skews caused by an increased or decreased demands of a load receiving the output voltage, among other possibilities.

### SUMMARY

This disclosure is generally directed to a multilevel converter with granular output voltage adjustment circuitry. The multilevel converter adjust a value of the output voltage with a reduced duration compared to other multilevel converters. The multilevel converter may provide the output voltage with a desired voltage value to one or more components in an electronic device. For example, the multilevel converter may provide the output voltage to a power supply rail and/or a ground terminal coupled to the one or more components in the electronic device. The multilevel converter may perform repeating and/or alternating patterns of energizing and de-energizing phases to generate the output voltage with the desired voltage value. The repeating patterns of energizing and de-energizing phases may be associated with coarse voltage adjustments and the alternating patterns of energizing and de-energizing phases may be associated with fine voltage adjustments. The multilevel converter may adjust the output voltage with a higher voltage adjustment step (e.g., rate) using the coarse voltage adjustments and/or the fine voltage adjustments compared to other multilevel converters.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device including a multilevel converter, according to embodiments of the present disclosure;

FIG. 2 is a front view of a handheld device representing an example of the electronic device of FIG. 1, according to embodiments of the present disclosure;

FIG. 3 is a front view of another handheld device representing another example of the electronic device of FIG. 1, according to embodiments of the present disclosure;

FIG. 4 is a perspective view of a notebook computer representing an example of the electronic device of FIG. 1, according to embodiments of the present disclosure;

FIG. 5 illustrates front and side views of a wearable electronic device representing another example of the electronic device of FIG. 1, according to embodiments of the present disclosure;

FIS. 6A is a block diagram illustrating an energizing phase of the multilevel converter of the electronic devices of FIGS. 1-5, according to embodiments of the present disclosure.

FIG. 6B is a block diagram illustrating a de-energizing phase of the multilevel converter of the electronic devices of FIGS. 1-5, according to embodiments of the present disclosure.

FIG. 7 is an example timing diagram illustrating adjusting and maintaining a voltage V_{C} across a flying capacitor of the multilevel converters of FIGS. 6A and 6B, according to embodiments of the present disclosure;

FIG. 8 is an example schematic diagram of output voltage adjustment circuitry of a controller of the multilevel converters of FIGS. 6A and 6B, according to embodiments of the present disclosure;

FIGS. 9A and 9B illustrate a flow diagram of a process of adjusting and maintaining the voltage V_{C} across the flying capacitor of the multilevel converter of FIGS. 6A, 6B, and 8 based on a desired output voltage or a desired voltage range of the output voltage of the multilevel converter, according to embodiments of the present disclosure; and

FIG. 10 is an example timing diagram illustrating timing differences between coarse and fine voltage adjustments for adjusting the output voltage or voltage V_{C} across the flying capacitor of the multilevel converter of FIGS. 6A, 6B, and 8 based on the operations of the flow diagram of FIGS. 9A and 9B, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1 % of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member or a set may include multiple members. Furthermore, the term “continuous” may correspond to an activity that occurs without interruption or a consecutive repetition with a relatively short time period therebetween.

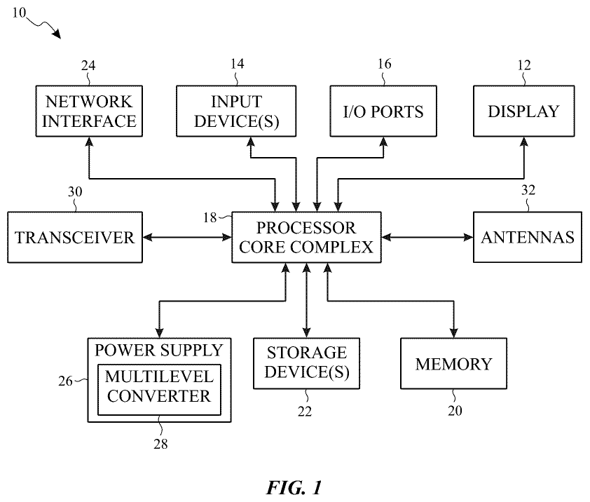

FIG. 1 is a block diagram of an electronic device 10 according to embodiments of the present disclosure. As is described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 may include an electronic display 12, one or more input devices 14, one or more input/output (I/O) ports 16, a processor core complex 18 having one or more processing circuitry(s) or processing circuitry cores, local memory 20, a main memory storage device 22, a network interface 24, a power source 26 (e.g., power supply), transceiver 30, and one or more antennas 32. The various components described in FIG. 1 may include hardware elements (e.g., circuitry), software elements (e.g., a tangible, non-transitory computer-readable medium storing executable instructions), or a combination of both hardware and software elements. It should be noted that the various depicted components may be combined into fewer components or separated into additional components. For example, the local memory 20 and the main memory storage device 22 may be included in a single component.

The processor core complex 18 is operably coupled with local memory 20 and the main memory storage device 22. Thus, the processor core complex 18 may execute instructions stored in local memory 20 and/or the main memory storage device 22 to perform operations, such as generating or transmitting image data to display on the electronic display 12. As such, the processor core complex 18 may include one or more processors, one or more general purpose microprocessors, one or more application specific integrated circuits (ASICs), one or more field programmable gate arrays (FPGAs), or any combination thereof. In some embodiments, a system on a chip (SoC) may include the processor core complex 18, among other things.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network.

The power source 26 may provide electrical power to the electronic display 12, the input devices 14, the I/O ports 16, the processor core complex 18, the local memory 20, the main memory storage device 22, the network interface 24, the power source 26, the transceiver 30, or a combination thereof, among other things. The power source 26 may include any suitable source of energy, such as a rechargeable lithium polymer (Li-poly) battery or an alternating current (AC) power converter.

The power source 26 may include one or more multilevel converters 28 to provide the electrical power to the various components of the electronic device 10. A multilevel converter 28 may provide an output voltage with a desired voltage value to one or more components in the electronic device 10. For example, the multilevel converter 28 may provide the output voltage to a power supply rail and/or a ground terminal coupled to the one or more components in the electronic device 10. The multilevel converter 28 may perform repeating and alternating patterns of energizing and de-energizing phases to generate the output voltage with the desired voltage value.

The transceiver 30 may include transmitters and receivers coupled via communication buses to transmit and receive data. In some embodiments, the transceiver 30 may include circuitry for data communication using any version of a serializer and deserializer (SerDes) interface, a peripheral component interconnect express (PCIe) interface, or any other viable interfacing protocol, such as various communication standards. It should be appreciated that the transceiver 30 may include and/or utilize any viable circuitry to facilitate data communication between multiple circuits, components, chips, integrated circuits (ICs), and so on. For example, the transceiver 30 may be coupled to a first chip and a second chip to provide a chip-to-chip (C2C) interface. Moreover, it should be appreciated that the primary circuit and the secondary circuit of the transceiver 30 may communicate via a wired link (e.g., a bus) or a wireless link. For example, the transceiver 30 may use any viable communication protocol, such as Wi-Fi, 4G LTE, or 5G NR, among other possibilities, to establish and communicate using the wireless link.

The I/O ports 16 may enable the electronic device 10 to interface with other electronic devices. For example, when a portable storage device is connected, the I/O port 16 may enable the processor core complex 18 to communicate data with the portable storage device. The input devices 14 may enable user interaction with the electronic device 10, for example, by receiving user inputs via a button, a keyboard, a mouse, a trackpad, or the like. The input device 14 may include touch-sensing components in the electronic display 12. The touch sensing components may receive user inputs by detecting occurrence or position of an object touching the surface of the electronic display 12.

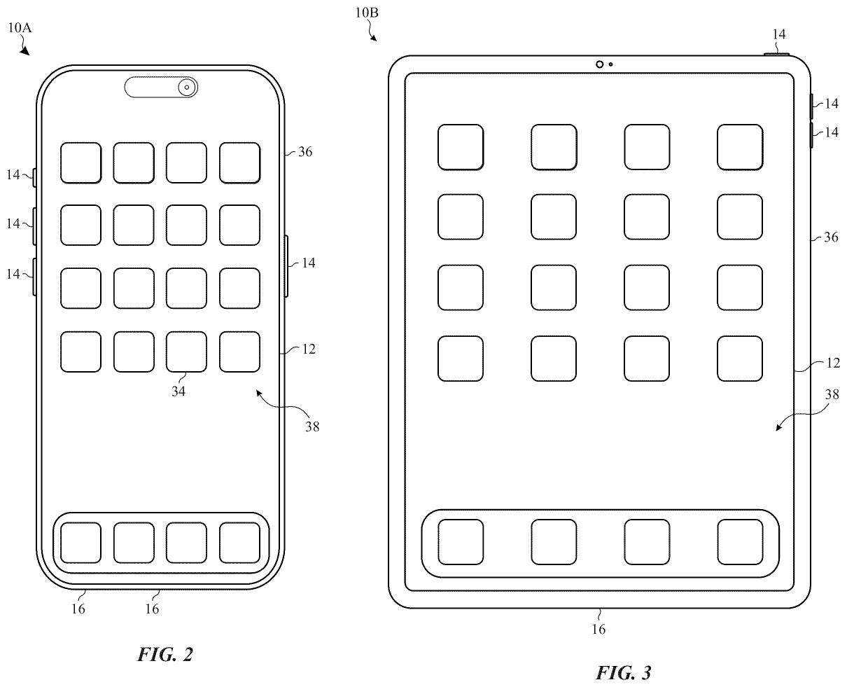

The electronic display 12 may include driver circuitry (e.g., display driver circuitry) and/or a display panel. The electronic device 10 may also have the one or more antennas 32 electrically coupled to the processor core complex 18. The electronic device 10 may be any suitable electronic device. To help illustrate, an example of the electronic device 10, a handheld device 10A, is shown in FIG. 2. The handheld device 10A may be a portable phone, a media player, a personal data organizer, a handheld game platform, or the like. For illustrative purposes, the handheld device 10A may be a smart phone, such as any IPHONE® model available from Apple Inc.

The handheld device 10A includes an enclosure 36 (e.g., housing). The enclosure 36 may protect interior components from physical damage or shield them from electromagnetic interference, such as by surrounding the electronic display 12. The electronic display 12 may display a graphical user interface (GUI) 38 having an array of icons. When an icon 34 is selected either by an input device 14 or a touch-sensing component of the electronic display 12, an application program may launch.

The input devices 14 may be accessed through openings in the enclosure 36. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, or toggle between vibrate and ring modes.

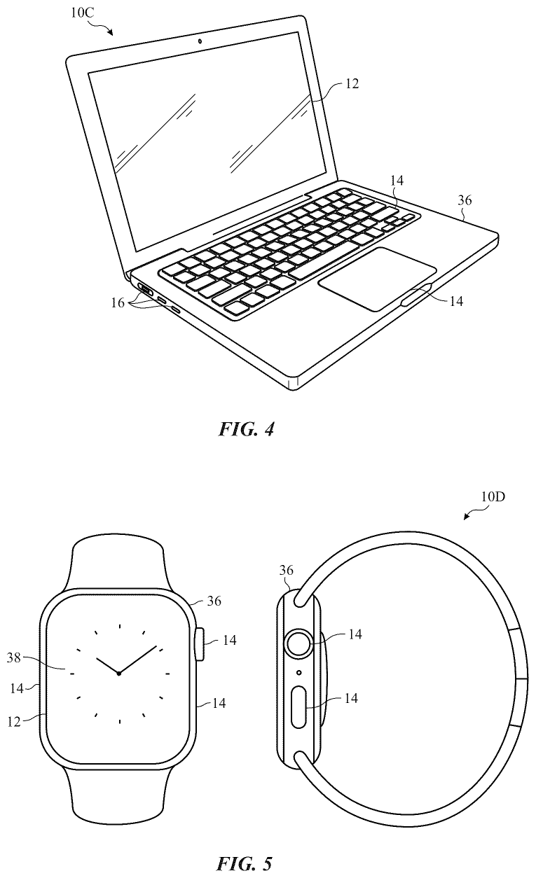

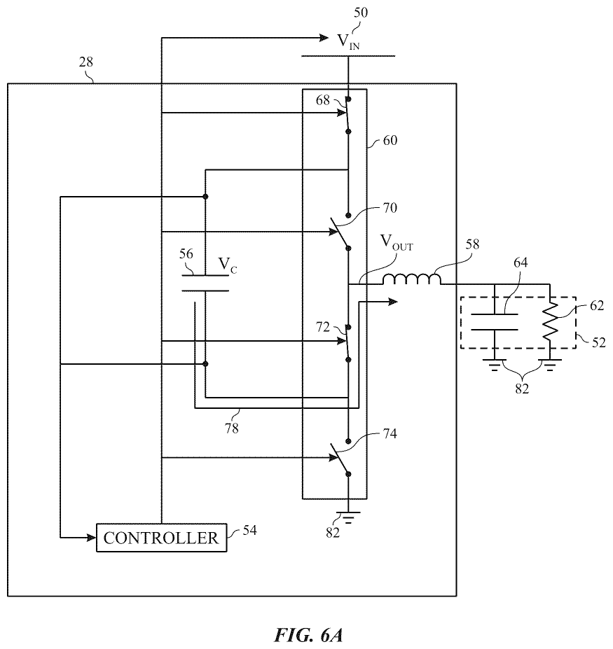

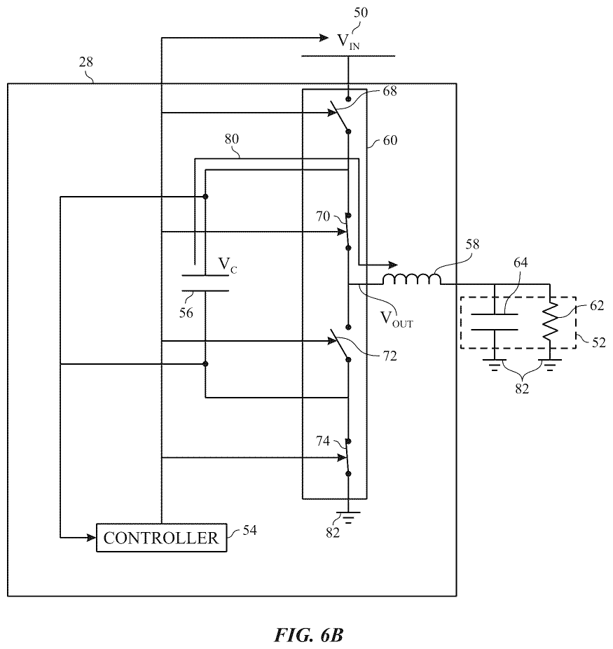

Another example of a suitable electronic device 10, specifically a tablet device 10B, is shown in FIG. 3. The tablet device 10B may be any IPAD® model available from Apple Inc. A further example of a suitable electronic device 10, specifically a computer 10C, is shown in FIG. 4. For illustrative purposes, the computer 10C may be any MACBOOK® or IMAC® model available from Apple Inc. Another example of a suitable electronic device 10, specifically a watch 10D, is shown in FIG. 5. For illustrative purposes, the watch 10D may be any APPLE WATCH® model available from Apple Inc. As depicted, the tablet device 10B, the computer 10C, and the watch 10D each also includes an electronic display 12, input devices 14, I/O ports 16, and an enclosure 36. The electronic display 12 may display a GUI 38.

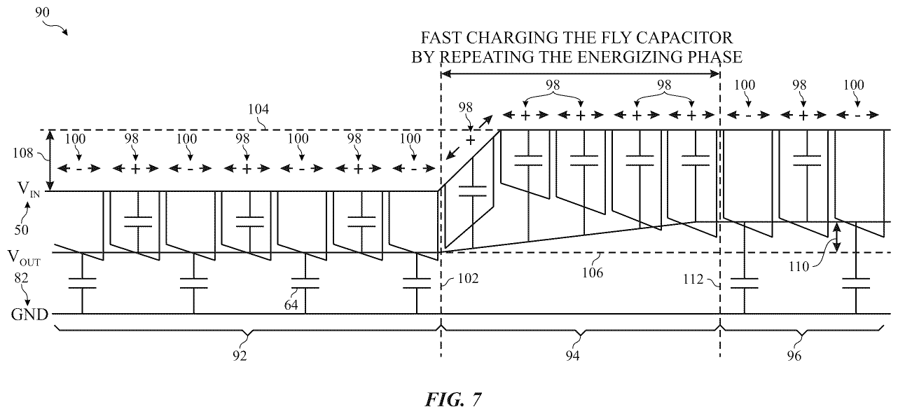

FIGS. 6A and 6B are block diagrams of the multilevel converter 28. As mentioned above, the electronic devices 10 discussed above with respect to FIGS. 1-5 may include the multilevel converter 28. In FIGS. 6A and 6B, the multilevel converter 28 may be coupled to a power supply 50 and a load 52, which represents any suitable one or more components of the electronic device 10 that may consume electricity provided by the multilevel converter 28. In some embodiments, the power source 26 of the electronic device 10 discussed above and shown in FIG. 1 may include the power supply 50. Moreover, the electronic display 12, the input devices 14, the I/O ports 16, the processor core complex 18, the local memory 20, the main memory storage device 22, the network interface 24, the power source 26, the transceiver 30, or a combination thereof, among other things, may include the load 52. The power supply 50 may provide an input voltage (V_{IN}) to the multilevel converter 28. When calibrated, the multilevel converter 28 may output an output voltage (V_{OUT}) having half (e.g., nearly half) of a voltage value of the input voltage.

The multilevel converter 28 may include a controller 54 (e.g., processing circuitry). In some cases, at least a portion of the controller 54 may be implemented using state machine circuits, processing circuitry, among other possibilities. In some embodiments, the controller 54 may adjust the input voltage based on receiving a desired voltage value of the output voltage. For example, the processor core complex 18 of the electronic device 10, the load 52, or any other viable component may provide instructions indicative of the desired voltage value of the output voltage to the controller 54. The controller 54 may transmit one or more control signals to the power supply 50 to cause provision of, and/or increase or decrease the input voltage based on the desired voltage value of the output voltage. The power supply 50 may adjust the input voltage based on receiving the one or more control signals.

As mentioned above, in some cases, the multilevel converter 28 may provide the output voltage having half (e.g., nearly half, slightly more than half) of the voltage value of the input voltage when calibrated. As such, the controller 54 may transmit the one or more control signals to cause reception of the input voltage with a voltage value that is double (e.g., nearly double) the desired voltage value of the output voltage. Alternatively or additionally, the power supply 50 may receive the one or more control signals indicative of the desired voltage value from any other viable circuitry, such as the processor core complex 18, the load 52, or any other viable component. In the depicted embodiment, the load 52 may include a resistor 62 and a load capacitor 64. It should be appreciated that in alternative or additional embodiments, the load 52 may include different or additional component.

The multilevel converter 28 may also include a flying capacitor 56, an inductor 58, and switching circuitry 60 including switches 68, 70, 72, and 74. The multilevel converter 28 may generate (e.g., initially generate), maintain, and/or calibrate the output voltage by adjusting and/or maintaining a voltage across the flying capacitor 56 (V_{C}). The voltage V_{C} across the flying capacitor 56 may correspond to the output voltage. The controller 54 may maintain the voltage V_{C} across the flying capacitor 56 and/or maintain the output voltage equal to or less than a peak voltage value (e.g., a first high threshold) and equal to or higher than a valley voltage value (e.g., a first low threshold). The peak voltage value and the valley voltage value may correspond to a desired voltage range across the flying capacitor 56 to generate the output voltage with the desired voltage value. Alternatively or additionally, the peak voltage value and the valley voltage value may correspond to a desired voltage range of the output voltage to generate the output voltage with the desired voltage value.

The controller 54 may maintain and/or adjust the V_{C} across the flying capacitor 56 by alternating between each energizing phase and each de-energizing phase of the multilevel converter 28 and/or consecutively repeating multiple energizing phases or de-energizing phases. The controller 54 may generate sets of control signals to cause adjusting and maintaining the V_{C} across the flying capacitor 56. For example, the controller 54 may generate a first set of control signals associated with an energizing phase of the multilevel converter 28.

The first set of control signals may cause coupling the flying capacitor 56 to the power supply 50 and the load 52. By way of example, the first set of control signals may adjust the switches 68, 70, 72, and 74 of the switching circuitry 60 to couple the flying capacitor 56 to the power supply 50 and the load 52 based on a phase of an electrical current of the output voltage and/or the desired voltage value of the output voltage. The phase of the electrical current and/or the desired voltage value of the output voltage may drive electrical current through the switching circuitry 60 to any viable output load. In some embodiments, the phase of the electrical current and/or the desired voltage value of the output voltage may drive the electrical current (e.g., inductor current) through the switching circuitry 60 to the inductor 58. As such, the first set of control signals may cause charging of the flying capacitor 56 while the flying capacitor 56 may provide the output voltage to the load 52. As such, the controller 54 may increase the output voltage of the multilevel converter 28 by consecutively repeating multiple energizing phases.

The controller 54 may generate a second set of control signals associated with a de-energizing phase of the multilevel converter 28. The second set of control signals may cause coupling the flying capacitor 56 to a ground terminal 82 and the load 52. By way of example, the second set of control signals may adjust the switches 68, 70, 72, and 74 of the switching circuitry 60 to couple the flying capacitor 56 to a ground terminal 82 and the load 52. The switching circuitry 60 may provide the electrical current and/or an output voltage (e.g., the desired output voltage value) to drive electrical current to any viable output load. In some embodiments, the switching circuitry 60 may provide the electrical current (e.g., inductor current) and/or the output voltage to drive electrical current to the inductor 58. As such, the second set of control signals may cause discharging of the flying capacitor 56 while the flying capacitor 56 may provide the output voltage to the load 52. As such, the controller 54 may decrease the output voltage of the multilevel converter 28 by consecutively repeating multiple de-energizing phases.

Each energizing phase and each de-energizing phase of the multilevel converter 28 may have a duration based on a width (e.g., pulse width, duration) of the respective control signals. For example, the controller 54 may generate each set of the control signals having a width (e.g., pulse width, duration) based on a duration of a single or multiple pulses of an input clock signal. In different cases, the controller 54 may generate the first set of control signals associated with the energizing phase and the second set of control signals associated with the de-energizing phase with the same width or with different widths. Moreover, the controller 54 may generate the first set of control signals such that the phase of the electrical current and/or the desired voltage value of the output voltage may cause driving the electrical current (e.g., the inductor current) through the switching circuitry 60 and/or to the load (e.g., the inductor 58).

With the foregoing in mind, the controller 54 may maintain the output voltage of the multilevel converter 28 by alternating between an energizing phase and a de-energizing phase with the same (e.g., approximately the same) duration to maintain a charge stored on the flying capacitor 56. For example, the output voltage may be maintained equal to or less than the first high threshold (V_{TH1}) and equal to or higher than the first low threshold (V_{TL1}). The controller 54 may increase the output voltage by alternating between an energizing phase and a de-energizing phase by providing the first set of control signals corresponding to the energizing phase with a longer duration or higher width compared to that of the second set of control signals. Moreover, the controller 54 may decrease the output voltage by alternating between an energizing phase and a de-energizing phase by providing the second set of control signals corresponding to the de-energizing phase with a longer duration or higher width compared to that of the first set of control signals.

FIG. 6A is a block diagram illustrating an energizing phase of the multilevel converter 28, according to embodiments of the present disclosure. In the depicted embodiment, the controller 54 may generate the first set of control signals to cause the switching circuitry 60 to form a first current path 78. The first set of control signals may close the switches 68 and 72 and open the switches 70 and 74 to form the first current path 78. For example, the controller 54 may drive a gate of the switches 68 and 72 while removing a gate voltage of the switches 70 and 74 when the switches 68, 70, 72, and 74 include n-type transistors. Alternatively or additionally, each of the switches 68, 70, 72, and 74 may include a p-type transistor. For example, the p-type transistors may close based on removing the respective gate voltage and open based on driving the respective gates.

In the energizing phase, the switching circuitry 60 may couple the flying capacitor 56 to the power supply 50 and the inductor 58. The flying capacitor 56 may charge based on coupling to the power supply 50. As such, the voltage V_{C} across the flying capacitor 56 may increase during the energizing phase. Moreover, the inductor 58 may draw electrical current from the flying capacitor 56 during the energizing phase. As such, the flying capacitor 56 may provide the electrical current to the inductor 58 during the energizing phase. The flying capacitor 56 may energize the inductor 58 based on voltage V_{C} across the flying capacitor 56 and based on the electrical current being drawn by the inductor 58. Accordingly, the inductor 58 may drive the output voltage based on being energized by the flying capacitor 56 by drawing the electrical current during the energizing phase.

FIG. 6B is a block diagram illustrating a de-energizing phase of the multilevel converter 28, according to embodiments of the present disclosure. In the depicted embodiment, the controller 54 may generate the second set of control signals to cause the switching circuitry 60 to form a second current path 80. The second set of control signals may open the switches 68 and 72 and close the switches 70 and 74 to form the second current path 80. For example, the controller 54 may drive a gate of the switches 70 and 74 while removing a gate voltage of the switches 68 and 72 when the switches 68, 70, 72, and 74 include n-type transistors. Alternatively or additionally, each of the switches 68, 70, 72, and 74 may include a p-type transistor.

In the de-energizing phase, the switching circuitry 60 may couple the flying capacitor 56 to the ground terminal 82 and the inductor 58. Similar to the energizing phase, the inductor 58 may draw electrical current from the flying capacitor 56 during the de-energizing phase. As such, the flying capacitor 56 may provide electrical current to the inductor 58 during the de-energizing phase. The flying capacitor 56 may discharge (e.g., de-energize) when providing the electrical current to the inductor 58 based on being coupled to the ground terminal 82 instead of the power supply 50 and based on the electrical current being drawn by the inductor 58. For example, the voltage V_{C} across the flying capacitor 56 may reduce during the de-energizing phase. The flying capacitor 56 may energize the inductor 58 based on the voltage V_{C} across the flying capacitor 56 and based on the electrical current being drawn by the inductor 58. Similar to the energizing phase, the inductor 58 may drive the output voltage based on being energized by the flying capacitor 56 by drawing the electrical current during the de-energizing phase.

Accordingly, the flying capacitor 56 may energize the inductor 58 based on the voltage V_{C} across the flying capacitor 56 during the energizing phase and the de-energizing phase. Moreover, the inductor 58 may drive the output voltage based on receiving the voltage V_{C} across the flying capacitor 56 during the energizing phase and the de-energizing phase. As such, a voltage value of the output voltage may correspond to (e.g., approximately correspond to) a voltage value of the V_{C}.

The controller 54 may maintain or adjust the voltage V_{C} across the flying capacitor 56 based on whether the voltage V_{C} and/or the output voltage are equal to or below the first high threshold and equal to or above the first low threshold (e.g., within the desired voltage range). The controller 54 monitors the voltage V_{C} across the flying capacitor 56 by receiving feedback currents or voltages indicative of the V_{C}. For example, the controller 54 may determine the output voltage of the multilevel converter 28 based on receiving, determining, or monitoring the voltage V_{C}.

In some cases, the controller 54 may determine that the output voltage and/or the voltage V_{C} are higher than the first high threshold. In such cases, the controller 54 may decrease the voltage V_{C} across the flying capacitor 56 by repeating (e.g., consecutively repeating) two or more de-energizing phases. For example, the controller 54 may consecutively generate the second set of control signals associated with the de-energizing phase at least twice.

In some cases, the controller 54 may determine that the output voltage and/or the voltage V_{C} are lower than the first low threshold. In such cases, the controller 54 may increase the voltage across the flying capacitor 56 by repeating (e.g., consecutively repeating) two or more energizing phases. For example, the controller 54 may consecutively generate the first set of control signals associated with the energizing phase at least twice.

Alternatively or additionally, the controller 54 may determine that the output voltage and/or the voltage V_{C} are equal to or below the first high threshold and equal to or above the first low threshold. In such cases, the controller 54 may maintain the voltage V_{C} across the flying capacitor 56 by alternatively (and consecutively) generating the first set of control signals and the second set of control signals. For example, the controller 54 may generate a first set of control signals followed by a second set of control signals, and may also generate the second set of control signals followed by a subsequent first set of control signals. Accordingly, the controller 54 may alternate between the energizing phases and the de-energizing phases to maintain the output voltage and/or the V_{C} between the first high threshold and the first low threshold.

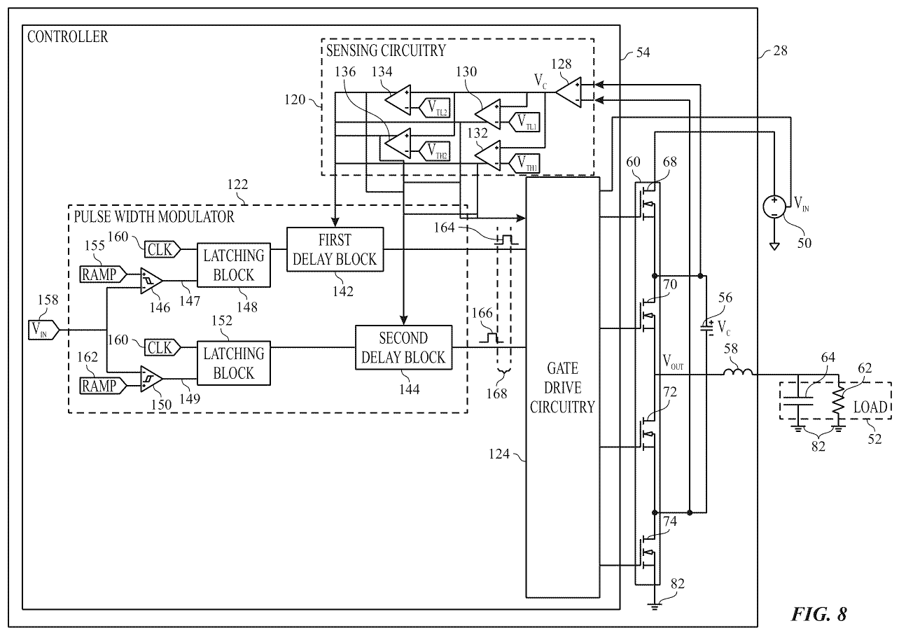

FIG. 7 is an example timing diagram 90 illustrating adjusting and maintaining the voltage V_{C} across the flying capacitor 56 of the multilevel converter 28, according to embodiments of the present disclosure. In particular, the controller 54 may maintain the voltage V_{C} across the flying capacitor 56 during time periods 92 and 96 and may adjust the voltage V_{C} across the flying capacitor 56 during a time period 94. Initially, the controller 54 may consecutively alternate between energizing phases 98 and the de-energizing phases 100 to maintain the output voltage and/or the V_{C} at or near a first voltage value 104 during the time period 92. The controller 54 may determine that the output voltage and/or the V_{C} may be equal to or below the first high threshold and equal to or above the first low threshold during the time period 92. For example, the first voltage value 104 may be between the first high threshold and the first low threshold.

At or near a time 102, the controller 54 may determine that the output voltage and/or the V_{C} are lower than the first low threshold. Alternatively or additionally, at or near the time 102, the controller 54 may receive an indication to increase the power supply 50 (e.g., input voltage, input voltage) by a first voltage difference 108 and/or increase the output voltage and/or the voltage V_{C} by a second voltage difference 110. For example, the second voltage difference 110 may be half (e.g., nearly half) of the first voltage difference 108. In specific cases, the controller 54 may receive or determine that the first voltage difference 108 and/or the second voltage difference 110 based on receiving an updated first high threshold and an updated first low threshold. The updated first high threshold and the updated first low threshold may be associated with the output voltage and/or the voltage V_{C}.

During the time 94, the controller 54 may repeat multiple consecutive energizing phases 98 to increase the output voltage and/or the voltage V_{C}. The controller 54 may increase the output voltage and/or the voltage V_{C} to approximately have a second voltage value 106 higher than the first voltage value 104 based on the first voltage difference 108 and/or the second voltage difference 110. For example, the second voltage value 106 may be between the updated first high threshold and the updated first low threshold. The updated first high threshold may be higher than the first high threshold and the updated first low threshold may be higher than the first low threshold.

At or near a time 112, the controller 54 may determine that the output voltage and/or the voltage V_{C} are increased equal to or below the updated first high threshold and equal to or above the updated first low threshold. As such, the controller 54 may consecutively alternate between the energizing phases 98 and the de-energizing phases 100 to maintain the output voltage and/or the V_{C} at or near the second voltage value 106 during the time period 96.

It should be appreciated that each energizing phase 98 and each de-energizing phase 100 may have a duration based on a width of the respective control signals. The width or duration of each first set of control signals and each second set of control signals may be equal or different. In some cases, the controller 54 may increase a width of one or more of the energizing phases 98 or decrease a width of one or more of the de-energizing phases 100 when consecutively alternating between the energizing phases 98 and the de-energizing phases 100 to increase the output voltage and/or the voltage V_{C}. Moreover, the controller 54 may decrease a width of one or more of the energizing phases 98 or increase a width of one or more of the de-energizing phases 100 when consecutively alternating between the energizing phases 98 and the de-energizing phases 100 to decrease the output voltage and/or the voltage V_{C}.

In some cases, switching operations of the switches 68, 70, 72, and 74 may provide gaps between consecutive energizing phases 98 and/or de-energizing phases 100. Moreover, in the depicted embodiment, an approximately average value of the voltage V_{C}, illustrated as moving approximately between the input voltage and the output voltage, may correspond to the output voltage. For example, the inductor 58 discussed above with respect to FIGS. 6A and 6B may drive the output voltage based on receiving and approximately averaging the voltage V_{C} during the energizing phases 98 and the de-energizing phases 100.

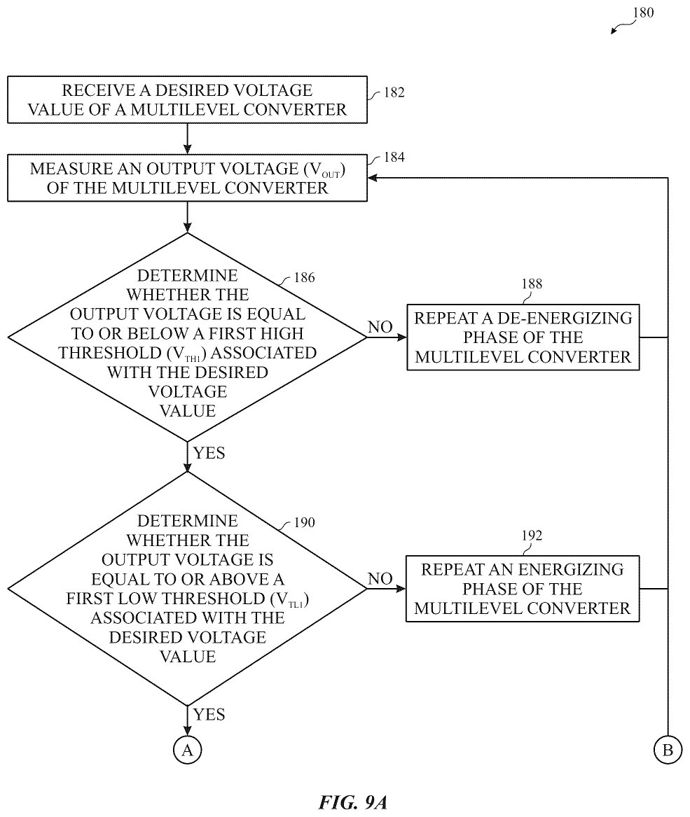

FIG. 8 is an example schematic diagram of output voltage adjustment circuitry of the controller 54 including sensing circuitry 120, a pulse width modulator 122, and gate driver circuitry 124, according to embodiments of the present disclosure. Although certain components are discussed here, it should be appreciated that in different embodiments, the sensing circuitry 120, the pulse width modulator 122, and/or the gate driver circuitry 124 may include additional or different components or may omit one or more of the components discussed here. Alternatively or additionally, the output voltage adjustment circuitry of the controller 54 may include additional or different circuitry to perform the operations mentioned above and/or discussed herein.

As mentioned above, each energizing phase and each de-energizing phase of the multilevel converter 28 may have a duration based on a width (e.g., pulse width, duration) of the respective control signals. In the depicted embodiment, the gate driver circuitry 124 may generate the first and second sets of control signals based on receiving a first delayed clock signal 164 and a second delayed clock signal 166. The gate driver circuitry 124 may determine a differential time 168 between the first delayed clock signal 164 and the second delayed clock signal 166. The gate driver circuitry 124 may generate each set of the control signals with a width (e.g., pulse width, duration) based on the differential time 168 between a respective first delayed clock signal 164 and second delayed clock signal 166.

The sensing circuitry 120 may monitor the voltage V_{C} across the flying capacitor 56. In the depicted embodiment, the sensing circuitry 120 may include comparators 128, 130, 132, 134, and 136. A first input terminal of the first comparator 128 may be coupled to a second terminal of the first switch 68, a first terminal of the second switch 70, and/or a first terminal of the flying capacitor 56. A second input terminal of the first comparator 128 may be coupled to a second terminal of the third switch 72, a first terminal of the fourth switch 74, and/or a second terminal of the flying capacitor 56. As such, the first comparator 128 may receive or determine the voltage V_{C} across the flying capacitor 56, or an indication thereof, during an operation of the multilevel converter 28. The first comparator 128 may output the voltage V_{C}, or the indication thereof, to a first input terminal of the comparators 130, 132, 134, and 136. The first comparator 128 may continue outputting the voltage V_{C}, or the indication thereof, continuously or based on a predetermined time interval. In response to receiving the voltage V_{C}, the comparators 130, 132, 134, and 136 may indicate whether to provide a coarse voltage increase, a fine voltage increase, a coarse voltage decrease, or a fine voltage decrease.

A second input terminal of the comparators 130, 132, 134, and 136 may receive the first low threshold (V_{TL1}), the first high threshold (V_{TH1}), the second low threshold (V_{TL2}), and the second high threshold (V_{TH2}), or indications thereof, respectively. The second low threshold may be higher than the first low threshold. The second high threshold may be lower than the first high threshold. The second comparator 130 may output a first indication based on the voltage V_{C} being below the first low threshold. The third comparator 132 may output a second indication based on the voltage V_{C} being above the first high threshold. The fourth comparator 134 may output a third indication based on the voltage V_{C} being below the second low threshold. The fifth comparator 136 may output a fourth indication based on the voltage V_{C} being above the second high threshold.

The controller 54 may provide a coarse voltage increase to the voltage V_{C} across the flying capacitor 56 in response to the first indication. The controller 54 may provide a fine voltage increase to the voltage V_{C} in response to the third indication. As such, the controller 54 may provide the output voltage with increased voltage value in response to the first indication and the third indication. Moreover, the controller 54 may provide a coarse voltage decrease to the voltage V_{C} in response to the second indication. The controller 54 may provide a fine voltage decrease to the voltage V_{C} in response to the fourth indication. Accordingly, the controller 54 may provide the output voltage with decreased voltage value in response to the second indication and the fourth indication, as will be appreciated.

The pulse width modulator 122 may generate the first delayed clock signal 164 and second delayed clock signal 166 based on receiving the indications from the comparators 130, 132, 134, and 136. In the depicted embodiment, the pulse width modulator 122 may include a first delay block 142, a second delay block 144, a fifth comparator 146, a first latching block 148, a sixth comparator 150, and a second latching block 152. The fifth comparator 146 may generate a first enable signal 147 based on receiving a first ramp signal 156 and a supply voltage 158. For example, the fifth comparator 146 may output the first enable signal 147 based on a voltage value of the first ramp signal 156 rising above (or falling below) that of the supply voltage 158. The first latching block 148 may receive a clock signal 160 and the first enable signal 147. The first latching block 148 may output a first clock signal to the first delay block 142. For example, the first latching block 148 may output the first clock signal by providing a portion of the clock signal 160 based on the first enable signal 147.

The sixth comparator 150 may generate a second enable signal 149 based on receiving a second ramp signal 162 and the supply voltage 158. The supply voltage 158 may be equal to or different from the input voltage of the power supply 50. For example, the power supply 26 of FIG. 1 may provide the supply voltage 158. The sixth comparator 150 may output the second enable signal 149 based on the second ramp signal 162 rising above (or falling below) the supply voltage 158. The first ramp signal 156 may be similar or different compared to the second ramp signal 162. The second latching block 152 may receive the clock signal 160 and the second enable signal 149. The second latching block 152 may output a second clock signal to the second delay block 144. For example, the second latching block 152 may output the second clock signal by providing a portion of the clock signal 160 based on the second enable signal 149.

In different cases, the first latching block 148 and the second latching block 152 may output the first clock signal and the second clock signal with equal or different timings. For example, an initial (e.g., default) timing difference between the first clock signal and the second clock signal may be associated with instantaneous voltage differences between the first ramp signal 156 and the second ramp signal 162. In any case, the first delay block 142 and the second delay block 144 may also receive the indications of the comparators 130, 132, 134, and 136 of the sensing circuitry 120 discussed above. The first delay block 142 and the second delay block 144 may delay the first clock signal and the second clock signal, respectively, based on the received indications. The first delay block 142 and the second delay block 144 may output the first delayed clock signal 164 and the second delayed clock signal 166 with a differential time 168 corresponding to a desired width of the first and/or second sets of control signals based on the received indications.

As mentioned above, the gate driver circuitry 124 may receive the first delayed clock signal 164 and the second delayed clock signal 166. The gate driver circuitry 124 may generate the input clock signal based on the first delayed clock signal 164 and the second delayed clock signal 166. For example, the gate driver circuitry 124 may generate each pulse of the input clock signal by determining the differential time 168 between each set of received pulses of the first delayed clock signal 164 and the second delayed clock signal 166. Moreover, the gate driver circuitry 124 may generate each set of control signals with a width (e.g., pulse width, duration) corresponding to the duration of the respective pulse of the input clock signal. Accordingly, the gate driver circuitry 124 may generate each set of the control signals with a width associated with the differential time 168 between a respective first delayed clock signal 164 and second delayed clock signal 166.

The gate driver circuitry 124 may also receive the indications of the comparators 130, 132, 134, and 136 of the sensing circuitry 120. The gate driver circuitry 124 may maintain the output voltage of the multilevel converter 28 by subsequently alternating between at least one energizing phase and at least one de-energizing phase based on a lack of the indications. By way of example, the gate driver circuitry 124 may maintain the voltage V_{C} across the flying capacitor 56 by subsequently alternating between at least one energizing phase and at least one de-energizing phase during the time periods 92 and 96 shown in FIG. 7. That is, the gate driver circuitry 124 may maintain the output voltage in response to the voltage V_{C} being equal to or lower than first and second high thresholds and equal to or higher than first and second low threshold. The first latching block 148 and the second latching block 152 may maintain equal (e.g., nearly equal) widths for a number of subsequent pulses based on the voltage V_{C} being equal to or lower than first and second high thresholds and equal to or higher than first and second low threshold. As such, the gate driver circuitry 124 may alternatingly generate the first and second control signals with the same (e.g., nearly the same) duration to alternatively provide the energizing phase and the de-energizing phase.

In some cases, the gate driver circuitry 124 may alternate between at least one energizing phase and respective de-energizing phase(s) based on receiving the third indication indicative of the voltage V_{C} being below the second low threshold and/or based on receiving the fourth indication based on the voltage V_{C} being above the second high threshold. The first latching block 148 and the second latching block 152 may increase (or decrease) a pulse width of one or more subsequent sets of control signals in response to the third indication and/or the fourth indication. For example, the first latching block 148 and the second latching block 152 may increase (or decrease) the differential time 168 between the first delayed clock signal 164 and the second delayed clock signal 166 in response to the third indication and/or the fourth indication. In specific cases, the first latching block 148 and the second latching block 152 may increase (or decrease) the pulse widths of every other subsequent pulse based on receiving the third indication and/or the fourth indication.

In some cases, the gate driver circuitry 124 may increase a pulse width of one or more subsequent energizing phases when subsequently alternating between at least one energizing phase and at least one de-energizing phase based on the voltage V_{C} being below the second low threshold. The gate driver circuitry 124 may use the increased pulse widths (e.g., of every other subsequent pulse) to generate one or more subsequent energizing phases with the increased pulse widths. In alternative or additional cases, the gate driver circuitry 124 may decrease a pulse width of one or more subsequent de-energizing phases when subsequently alternating between the energizing and de-energizing phases based on the voltage V_{C} being below the second low threshold. The gate driver circuitry 124 may use the decreased pulse widths (e.g., of every other subsequent pulse) to generate one or more subsequent de-energizing phases with the decreased pulse widths. As such, the gate driver circuitry 124 may increase the voltage V_{C} across the flying capacitor 56 by providing the fine voltage increase in response to the voltage V_{C} being below the second low threshold.

In some cases, the gate driver circuitry 124 may increase a pulse width of one or more subsequent de-energizing phases when subsequently alternating between at least one energizing phase and at least one de-energizing phase based on the voltage V_{C} being above the second high threshold. The gate driver circuitry 124 may use the increased pulse widths (e.g., of every other subsequent pulse) to generate one or more subsequent de-energizing phases with the increased pulse widths. In alternative or additional cases, the gate driver circuitry 124 may decrease a pulse width of one or more subsequent energizing phases when subsequently alternating between the energizing and de-energizing phases based on the voltage V_{C} being above the second high threshold. The gate driver circuitry 124 may use the decreased pulse widths (e.g., of every other subsequent pulse) to generate one or more subsequent energizing phases with the decreased pulse widths. As such, the gate driver circuitry 124 may decrease the voltage V_{C} across the flying capacitor 56 by providing the fine voltage decrease in response to the voltage V_{C} being above the second high threshold.

The gate driver circuitry 124 may increase the output voltage of the multilevel converter 28 by repeating a number of consecutive energizing phases based on the voltage V_{C} being below the first low threshold. In different cases, the first latching block 148 and the second latching block 152 may maintain equal (e.g., nearly equal) widths and/or increase or decrease the widths of one or more subsequent pulses (e.g., every other subsequent pulse) based on the voltage V_{C} being below the first low threshold. In any case, the gate driver circuitry 124 may increase the voltage V_{C} across the flying capacitor 56 by providing the coarse voltage increase in response to the voltage V_{C} being below the first low threshold by repeating at least two consecutive energizing phases.

The gate driver circuitry 124 may decrease the output voltage of the multilevel converter 28 by repeating a number of consecutive de-energizing phases based on the voltage V_{C} being above the first high threshold. In different cases, the first latching block 148 and the second latching block 152 may maintain equal (e.g., nearly equal) widths and/or increase or decrease the widths of one or more subsequent pulses (e.g., every other subsequent pulse) based on the voltage V_{C} being above the first high threshold. In any case, the gate driver circuitry 124 may decrease the voltage V_{C} across the flying capacitor 56 by providing the coarse voltage decrease in response to the voltage V_{C} being above the first high threshold by repeating at least two consecutive de-energizing phases.

With the foregoing in mind, the controller 54 may continuously, repeatedly, and/or consecutively repeat or switch between maintaining, providing the coarse voltage increase, providing the fine voltage increase, providing the coarse voltage decrease, and/or providing the fine voltage decrease to the output voltage. For example, the controller 54 may repeat or switch between these operations based on continuously, repeatedly, and/or consecutively monitoring the voltage V_{C} across the flying capacitor 56. In some embodiments, the first low threshold, the first high threshold, the second low threshold, and the second high threshold, or indications thereof, may be updated. For example, the controller 54 may receive an updated value for one or more of the threshold via the electronic display 12, the input devices 14, the I/O ports 16, the processor core complex 18, the local memory 20, the main memory storage device 22, the network interface 24, the power source 26, the transceiver 30, or a combination thereof, among other possibilities. It should be appreciated that the controller 54 may repeat or switch between maintaining, providing the coarse voltage increase, providing the fine voltage increase, providing the coarse voltage decrease, and/or providing the fine voltage decrease based on an updated threshold.

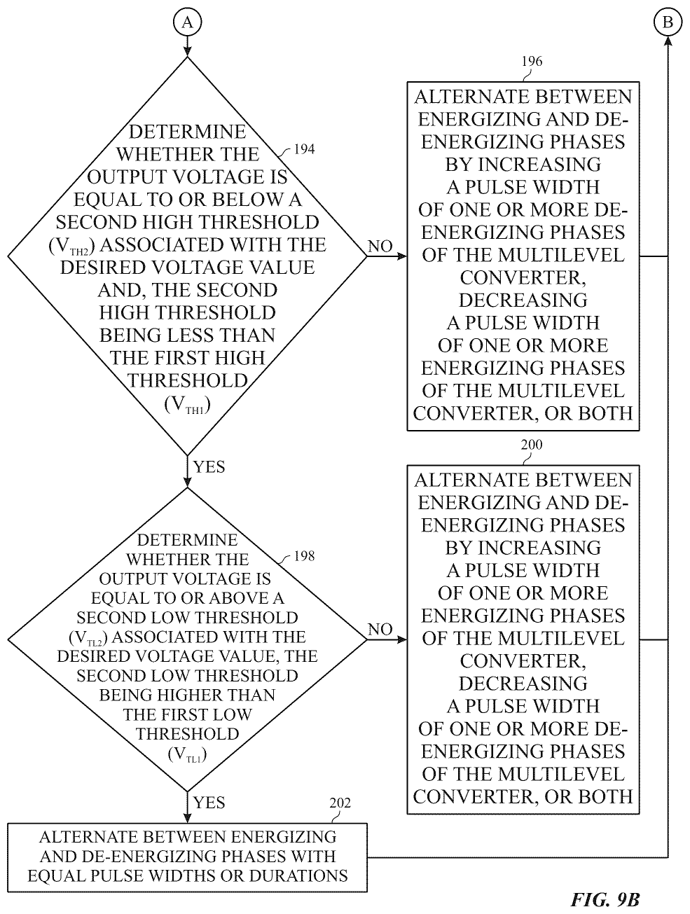

FIGS. 9A and 9B illustrate a flow diagram of a process 180 of adjusting and maintaining the voltage V_{C} across the flying capacitor 56 of the multilevel converter 28 based on a desired voltage range of the output voltage of the multilevel converter 28, according to embodiments of the present disclosure. Although the following description of the process 180 is described with reference to the controller 54 of the multilevel converter 28, it should be noted that the process 180 may be performed by one or more other controllers and/or one or more processors. For example, in some embodiments, the processor core complex 18 may perform at least a portion of the operations discussed below. Additionally, although the following process 180 describes a number of operations that may be performed, it should be noted that the process 180 may be performed in a variety of suitable orders, all of the operations may not be performed, and/or one or more operations may be additionally performed.

At process block 182, the controller 54 may receive (e.g., monitor for) a desired voltage value of the multilevel converter 28. The desired voltage may be associated with the output voltage of the multilevel converter 28, the voltage V_{C} across the flying capacitor 56, among other possibilities. In some cases, the controller 54 may receive or retrieve the desired voltage stored with the controller 54, the local memory 20, and/or the main memory storage device 22. Alternatively or additionally, the controller 54 may receive the desired voltage via the electronic display 12, the input devices 14, the I/O ports 16, the processor core complex 18, the network interface 24, and/or the transceiver 30, among other possibilities.

At process block 184, the controller 54 may measure or receive the output voltage of the multilevel converter 28. The controller 54 may receive feedback currents or voltages associated with the voltage V_{C} across the flying capacitor 56 discussed above. For example, the controller 54 may determine the output voltage based on the Voltage V_{C}. Alternatively or additionally, the controller 54 may receive feedback currents or voltages associated with the output voltage at or near the inductor 58 and/or the load 52 shown in FIGS. 6 and 8.

At process block 186, the controller 54 may determine whether the output voltage is equal to or below the first high threshold. The controller 54 may receive or determine (e.g., calculate) the first high threshold based on the desired voltage value. The controller 54 may proceed to operations of process block 188 based on determining that the output voltage is higher than the first high threshold.

At process block 188, the controller 54 may consecutively repeat two or more de-energizing phases of the multilevel converter 28 to lower the output voltage by decreasing the voltage V_{C} across the flying capacitor 56. For example, the controller 54 may provide a coarse voltage decrease based on operations of the process block 188. The controller 54 may return to operations of process block 184 to measure or receive the output voltage of the multilevel converter 28. In some cases, the output voltage may be reduced based on the operations of process block 188.

The controller 54 may proceed to operations of process block 190 based on determining that the output voltage is equal to or below the first high threshold. At process block 190, the controller 54 may determine whether the output voltage is equal to or above the first low threshold. The controller 54 may receive or determine (e.g., calculate) the first low threshold based on the desired voltage value. The controller 54 may proceed to operations of process block 192 based on determining that the output voltage is lower than the first low threshold.

At process block 192, the controller 54 may consecutively repeat two or more energizing phases of the multilevel converter 28 to increase the output voltage by increasing the voltage V_{C} across the flying capacitor 56. For example, the controller 54 may provide a coarse voltage increase based on operations of the process block 192. The controller 54 may return to operations of process block 184 to measure or receive the output voltage of the multilevel converter 28. In some cases, the output voltage may be increased based on the operations of process block 192.

The controller 54 may proceed to operations of process block 194 based on determining that the output voltage is equal to or above the first high threshold. At process block 194, the controller 54 may determine whether the output voltage is equal to or below the second high threshold. The controller 54 may receive or determine (e.g., calculate) the second high threshold based on the desired voltage value. The controller 54 may proceed to operations of process block 196 based on determining that the output voltage is higher than the second high threshold.

At process block 196, the controller 54 may consecutively alternate between two or more energizing and de-energizing phases by increasing a pulse width of one or more of the de-energizing phases and/or decreasing a pulse width of one or more of the energizing phases. As such, the controller 54 may lower the output voltage based on decreasing the voltage V_{C} across the flying capacitor 56. The controller 54 may provide a fine voltage decrease based on operations of the process block 196. Moreover, the output voltage may be reduced based on the operations of process block 196. In specific cases, the operations of the process block 188 may increase the output voltage faster and/or with a higher voltage increase step compared to the operations of the process block 196. As such, the multilevel converter 28 may calibrate and/or self-balance with more granular adjustments and/or with reduced duration compared to other multilevel converters. The controller 54 may return to operations of process block 184 to measure or receive the output voltage of the multilevel converter 28.

The controller 54 may proceed to operations of process block 198 based on determining that the output voltage is equal to or below the second high threshold. At process block 198, the controller 54 may determine whether the output voltage is equal to or above the second low threshold. The controller 54 may receive or determine (e.g., calculate) the second low threshold based on the desired voltage value. The controller 54 may proceed to operations of process block 200 based on determining that the output voltage is lower than the second low threshold.

At process block 200, the controller 54 may consecutively alternate between two or more energizing and de-energizing phases by increasing a pulse width of one or more of the energizing phases and/or decreasing a pulse width of one or more of the de-energizing phases. As such, the controller 54 may increase the output voltage based on increasing the voltage V_{C} across the flying capacitor 56. The controller 54 may provide a fine voltage increase based on operations of the process block 200. Moreover, the output voltage may be increased based on the operations of process block 200. In specific cases, the operations of the process block 192 may decrease the output voltage faster and/or with a higher voltage decrease step compared to the operations of the process block 200. As such, the multilevel converter 28 may calibrate and/or self-balance with more granular adjustments and/or with reduced duration compared to other multilevel converters. The controller 54 may return to operations of process block 184 to measure or receive the output voltage of the multilevel converter 28.

The controller 54 may proceed to operations of process block 202 based on determining that the output voltage is equal to or above the second low threshold. At process block 198, the controller 54 may alternate between the energizing and de-energizing phases with equal (e.g., nearly equal) pulse widths and/or durations. The controller 54 may maintain the output voltage in response to the output voltage (or the voltage V_{C}) being equal to or lower than first and second high thresholds and equal to or higher than first and second low threshold. The controller 54 may return to operations of process block 184 to measure or receive the output voltage of the multilevel converter 28 to maintain and/or adjust the output voltage using the fine or coarse voltage adjustments based on the operations discussed above.

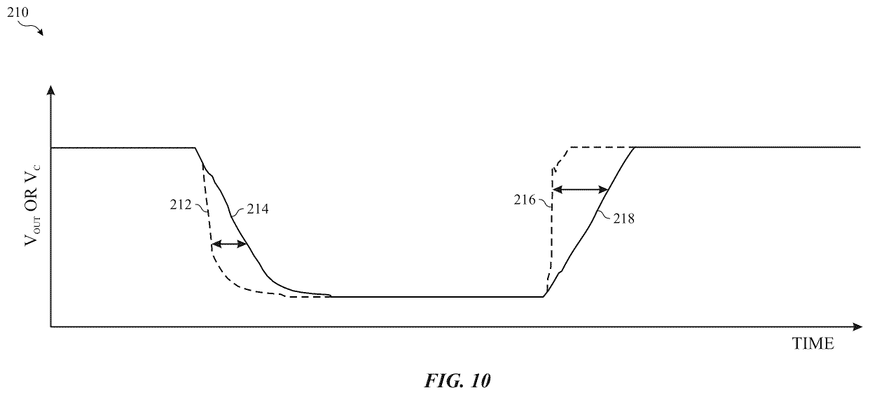

FIG. 10 is an example timing diagram 210 illustrating timing differences between coarse and fine voltage adjustments for adjusting the output voltage or voltage V_{C} across the flying capacitor 56 of the multilevel converter 28, according to embodiments of the present disclosure. In some cases, the multilevel converter 28 may calibrate and/or self-balance with more granular adjustments and/or with reduced duration compared to other multilevel converters based on using the coarse voltage adjustments in addition to (e.g., or in place of) the fine voltage adjustments. It should be appreciated that the timing diagram 210 is only for illustration purposes.

By way of example, a curve 212 may be associated with performing the coarse voltage decrease to lower the output voltage or voltage V_{C} from an initial voltage to a first desired voltage. Moreover, a curve 214 may be associated with performing the fine voltage decrease to lower the output voltage or voltage V_{C} from the initial voltage to the first desired voltage. As shown in the example timing diagram 210, the controller 54 may decrease the output voltage faster and/or with a higher voltage decrease step (e.g., rate) using the coarse voltage decrease compared to the fine voltage decrease. Similarly, a curve 216 may be associated with performing the coarse voltage increase to increase the output voltage or voltage V_{C} from the first desired voltage to a second desired voltage (e.g., the initial voltage). Moreover, a curve 218 may be associated with performing the fine voltage increase to increase the output voltage or voltage V_{C} from the first desired voltage to the second desired voltage. As shown in the example timing diagram 210, the controller 54 may increase the output voltage faster and/or with a higher voltage decrease step (e.g., rate) using the coarse voltage increase compared to the fine voltage increase.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A multilevel converter comprising:
a capacitor, wherein a voltage across the capacitor corresponds to an output voltage;
switching circuitry comprising a plurality of switches, wherein the switching circuitry is coupled to the capacitor;
a controller coupled to the capacitor and the plurality of switches, wherein the controller is configured to:
adjust the output voltage at least in part by consecutively repeating at least two energizing phases to charge the capacitor or consecutively repeating at least two de-energizing phases to discharge the capacitor; and
maintain the output voltage at least in part by consecutively alternating between one energizing phase and one de-energizing phase to maintain a charge stored on the capacitor.

2. The multilevel converter of claim 1, wherein the switching circuitry is configured to couple to a voltage supply and a ground terminal.

3. The multilevel converter of claim 2, wherein the controller is configured to couple a first terminal of the capacitor to the voltage supply and a second terminal of the capacitor a load in the energizing phases to charge the capacitor.

4. The multilevel converter of claim 2, wherein the controller is configured to couple a first terminal of the capacitor to the ground terminal and a second terminal of the capacitor a load in the de-energizing phases to discharge the capacitor.

5. The multilevel converter of claim 1, wherein the controller is configured to adjust the voltage across the capacitor at least in part by consecutively alternating between the energizing phases and the de-energizing phases based on adjusting a duration of at least one of the energizing phases or the de-energizing phases.

6. The multilevel converter of claim 1, wherein the controller is configured to:
receive an indication of the output voltage;
adjust the voltage across the capacitor based on the output voltage being above a first threshold;
adjust the voltage across the capacitor based on the output voltage being below a second threshold that is lower than the first threshold; and
maintain the voltage across the capacitor based on the output voltage being equal to or below the first threshold and equal to or above the second threshold.

7. The multilevel converter of claim 1, wherein the controller is configured to adjust the voltage across the capacitor based on a change in an input voltage of a voltage supply coupled to the switching circuitry or a voltage change of the capacitor.

8. The multilevel converter of claim 1, wherein the controller is configured to generate one or more control signals to close or open each of the plurality of switches to adjust and maintain the voltage across the capacitor.

9. A multilevel converter comprising:
a capacitor, wherein a voltage across the capacitor corresponds to an output voltage; and
a controller coupled to the capacitor, wherein the controller is configured to:
maintain the output voltage at least in part by coupling the capacitor to a voltage supply and a load during a first time duration and coupling the capacitor to a ground terminal and the load during a second time duration, wherein the first time duration and the second time durations are consecutive;
increase the output voltage at least in part by coupling the capacitor to the voltage supply and the load during at least two consecutive time durations; and
decrease the output voltage at least in part by coupling the capacitor to the ground terminal and the load during at least the two consecutive time durations.

10. The multilevel converter of claim 9, wherein the controller is configured to:
couple a first terminal of the capacitor to the voltage supply and a second terminal of the capacitor the load in an energizing phase of the multilevel converter to charge the capacitor; and
couple the first terminal of the capacitor to the ground terminal and the second terminal of the capacitor the load in a de-energizing phase of the multilevel converter to discharge the capacitor.

11. The multilevel converter of claim 9, wherein a duration of the first time duration corresponds to that of the second time duration, and wherein the first time duration is followed by the second time duration.

12. The multilevel converter of claim 9, wherein the controller is configured to:
form a first current path from the capacitor to the load via a first switch when coupling the capacitor to the voltage supply and the load; and
form a second current path from the capacitor to the load via a second switch when coupling the capacitor to the ground terminal and the load.

13. The multilevel converter of claim 9, wherein the controller is configured to:
maintain the voltage across the capacitor based on the output voltage being equal to or below a first threshold and equal to or above a second threshold;
increase the voltage across the capacitor based on the output voltage being below the second threshold; and
decrease the voltage across the capacitor based on the output voltage being above the first threshold.

14. The multilevel converter of claim 9, wherein the controller is configured to increase or decrease the voltage across the capacitor based on a change in an input voltage of the voltage supply or a voltage change of the capacitor.

15. Tangible non-transitory, computer-readable media storing instructions that when executed at least in part by processing circuitry, cause the processing circuitry to:
receive an indication of an output voltage of a multilevel converter;
determine whether the output voltage is equal to or below a first threshold and equal to or above a second threshold;
output first control signals to cause maintaining the output voltage based on the output voltage being equal to or below the first threshold and equal to or above the second threshold at least in part by coupling a capacitor of the multilevel converter to a voltage supply and a load during a first time duration and coupling the capacitor to a ground terminal and the load during a second time duration, wherein the first time duration and the second time duration are consecutive;
output second control signals to cause increasing the output voltage at least in part by coupling the capacitor to the voltage supply and the load during the first and second time durations based on the output voltage being below the second threshold; and
output third control signals to cause decreasing the output voltage at least in part by coupling the capacitor to the ground terminal and the load during the first and second time durations based on the output voltage being above the first threshold.

16. The tangible, non-transitory, computer-readable media of claim 15, wherein the instructions cause the processing circuitry to determine the first threshold and the second threshold based on an input voltage of the voltage supply.

17. The tangible, non-transitory, computer-readable media of claim 15, wherein the instructions cause the processing circuitry to output fourth control signals to cause increasing the output voltage at least in part by coupling the capacitor to the voltage supply and the load during the first time duration and coupling the capacitor to the ground terminal and the load during the second time duration, wherein the first time duration is longer than the second time duration.

18. The tangible, non-transitory, computer-readable media of claim 15, wherein the instructions cause the processing circuitry to output fifth control signals to cause decreasing the output voltage at least in part by coupling the capacitor to the voltage supply and the load during the first time duration and coupling the capacitor to the ground terminal and the load during the second time duration, wherein the first time duration is shorter than the second time duration.

19. The tangible, non-transitory, computer-readable media of claim 15, wherein the first control signals, the second control signals, and the third control signals close and open one or more switches of switching circuitry of the multilevel converter to maintain, increase, and decrease the output voltage.

20. The tangible, non-transitory, computer-readable media of claim 15, wherein a duration of the first time duration corresponds to that of the second time duration.
